(19) United States
(12) Patent Application Publication
(10) Pub. No.: US 2015/0173306 A1
(43) Pub. Date: Jun. 25, 2015

(54) PLANT GROWTH APPARATUS AND METHOD

(71) Applicant: Bigelow Brook Farm, LLC, Eastford, CT (US)

(72) Inventor: Robert J. Torcellini, Eastford, CT (US)

(21) Appl. No.: 14/573,680

(22) Filed: Dec. 17, 2014

Related U.S. Application Data
(60) Provisional application No. 61/918,449, filed on Dec. 19, 2013.

(51) Int. Cl. A01G 9/02

(52) U.S. Cl. CPC A01G 9/02

(57) ABSTRACT

Some embodiments include a plant cradle including a main body including a first and second end. Some embodiments include a segmented main body and at least one portion pivotable with respect to another. In some embodiments, the plant cradle includes an outer surface extending from the first to the second end and which includes a ridge adjacent a first surface. The plant cradle also includes an aperture extending at least partially through the main body from the first end towards the second end. Further, in some embodiments, the plant cradle includes a hinge section coupled to the at least two portions. The hinge section is configured to enable at least two portions to be pivoted with respect to each other about the hinge section. In some embodiments, the main body can be a polymer, a foamed polymer, a polymer fiber, polymer mesh, polymer weave, or polymer mat.

### RELATED APPLICATIONS

This application claims priority from U.S. Provisional Application No. 61/918,449 entitled “Plant Growth Apparatus and Method” filed on Dec. 19, 2013, the entire contents of which are incorporated herein by reference.

### BACKGROUND

Hydroponic cultivation has become a common and powerful method for the mass-production of certain plants species such as lettuce and other leafy plants used for human consumption. In many cases, plants yields per unit area can exceed 5 to 10 times that provided by traditional soil-based farming techniques. Hydroponic methods generally include adding nutrient solution prior to planting or transplanting. A germinated or un-germinated plant seed or immature plant is placed in a tapered net pot that includes a growing medium, which is then immersed in nutrient solution. Plants can be placed in close proximity when small and moved further apart as they mature.

Non-circulating hydroponic growing methods allow further savings as an entire crop can be grown with only an initial application of water. Capillary action and direct root uptake of water and nutrients negates the need for artificial circulation, thereby saving on the use of electricity that is normally required for pumping. Further cost savings can be realized as associated equipment for aeration and circulation is not required, and additional labor is only required during plant harvesting.

The use of net pots and associated growing medium to support the plant during the initial growth stage and/or through to plant maturity and harvesting is a major proportion of the capital cost of a typical hydroponic farm. Moreover, the growth medium, which often comprises bulky materials including stones and rocks, can add significant weight to a hydroponic platform or raft system. Growers can use rock wool or peat pellets to hold individual plants within a hydroponic platform, however these systems are normally not easily reused.

### SUMMARY

Some embodiments include a plant cradle comprising a segmented main body including a first end and a second end, and comprising at least one portion pivotable with respect to another portion. The plant cradle also comprises an outer surface extending from the first end to the second end that comprises at least one ridge adjacent at least one first surface. The plant cradle also comprises at least one aperture extending at least partially through the segmented main body from the first end towards the second end and is configured and arranged to hold a plant. Further, the plant cradle comprises at least one hinge section coupled to the portions. The at least one hinge section is configured to enable the portions to be pivoted with respect to each other about the at least one hinge section.

In some embodiments, the portions comprise a first half and a second half. In some embodiments, the first half is shaped substantially identically to the second half. In some other embodiments of the invention, the first half and the second half are dissimilarly shaped. In some embodiments, the at least one first surface comprises a substantially concave surface.

In some embodiments, the segmented main body comprises a polymer. In some embodiments, the polymer comprises a polyethylene-based foamed polymer. In some embodiments of the invention, the polymer comprises at least one of a polyethylene polymer, polyurethane-based foamed polymer, a polyether-based foamed polymer, a polypropylene-based foamed polymer, a polystyrene-based foamed polymer, a polymethacrylimide-based foamed polymer, a polyvinylchloride-base foamed polymer, a rubber-based foamed polymer, a cellulosic-based polymer, plant-derived cellulosic fibers, plant-oil derived polymer, and mixtures thereof.

In some embodiments, the at least one aperture is positioned in the first half. In some further embodiments, the at least one aperture is positioned in the second half. In other embodiments, at least a portion of the at least one aperture extends through at least a portion of the first half and at least a portion of the at least one aperture extends through at least a portion of the second half and is configured and arranged to hold a plant. Further, some embodiments include at least one aperture that comprises a channel extending through the first end and through the second end.

Some embodiments of the invention include a plant cradle comprising a main body including a first end and a second end, and an outer surface extending from the first end to the second end. The outer surface comprises at least one ridge adjacent and at least one first surface. Further, the plant cradle comprises an aperture extending at least partially through the main body from the first end towards the second end.

In some embodiments, the main body comprises a polymer. In some embodiments, the polymer of the main body comprises a foamed polymer. In some further embodiments, the polymer of the main body comprises at least one of a polyethylene-based polymer, a polypolyurethane-based polymer, a polyether-based polymer, a polypropylene-based polymer, a polystyrene-based polymer, a polymethacrylimide-based polymer, a polyvinylchloride-base polymer, a rubber-based polymer, a cellulosic-based polymer, plant-derived cellulosic fibers, plant-oil derived polymer, and mixtures thereof. In some embodiments, the main body comprises a polymer fiber, mesh, weave or mat.

### DESCRIPTION OF THE DRAWINGS

FIG. 1 is a perspective view of a plant cradle according to some embodiments of the invention.

FIG. 2 is a top view of a plant cradle according to some embodiments of the invention.

FIG. 3 is a perspective view of one half of the plant cradle of FIG. 1 according to some embodiments of the invention.

FIG. 4 is a top perspective view of one half of the plant cradle of FIG. 1 according to some embodiments of the invention.

FIG. 5A illustrates a perspective view of a growing platform including a plant cradle according to some embodiments of the invention.

FIG. 5B illustrates a perspective view of a growing platform including multiple plant cradles according to some embodiments of the invention.

FIG. 6A illustrates a perspective view of growing platform including a plurality of plant cradles according to some embodiments of the invention.

FIG. 6B is a close-up perspective view of a plant cradle with a plant positioned within a growing platform according to some embodiments of the invention.

FIG. 6C is a close-up view of a plant removed from a growing platform partially separated from a plant cradle according to one embodiment of the invention.

FIG. 7A is a front perspective view of a plant and plant cradle removed from a growing platform according to some embodiments of the invention.

FIG. 7B is close-up view of a plant removed from a growing platform with one half of a plant cradle separated according to one embodiment of the invention.

FIG. 8A illustrates a top view of the plant cradle of FIG. 1 depicting a separation of two halves according to one embodiment of the invention.

FIG. 8B illustrates a perspective view of the plant cradle of FIG. 1 depicting a two hinged halves according to one other embodiment of the invention.

FIG. 9A is a perspective view of a plant cradle according to another embodiment of the invention.

FIG. 9B is a top view of one half of the plant cradle of FIG. 9A according to some embodiments of the invention.

FIG. 9C illustrates a perspective view of the plant cradle of FIG. 9A depicting two hinged portions according to some embodiments of the invention.

FIG. 9D illustrates a top view of the plant cradle of FIG. 9A depicting a separation of two halves according to some embodiments of the invention.

FIG. 10 illustrates a perspective view of a growing platform including multiple plant cradles according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include containers for germinating and raising plants. In some embodiments, the invention includes containers for germinating and raising plants that are re-useable. Herein throughout a single container will be termed “plant cradle” and a plurality of containers will be termed “plant cradles”.

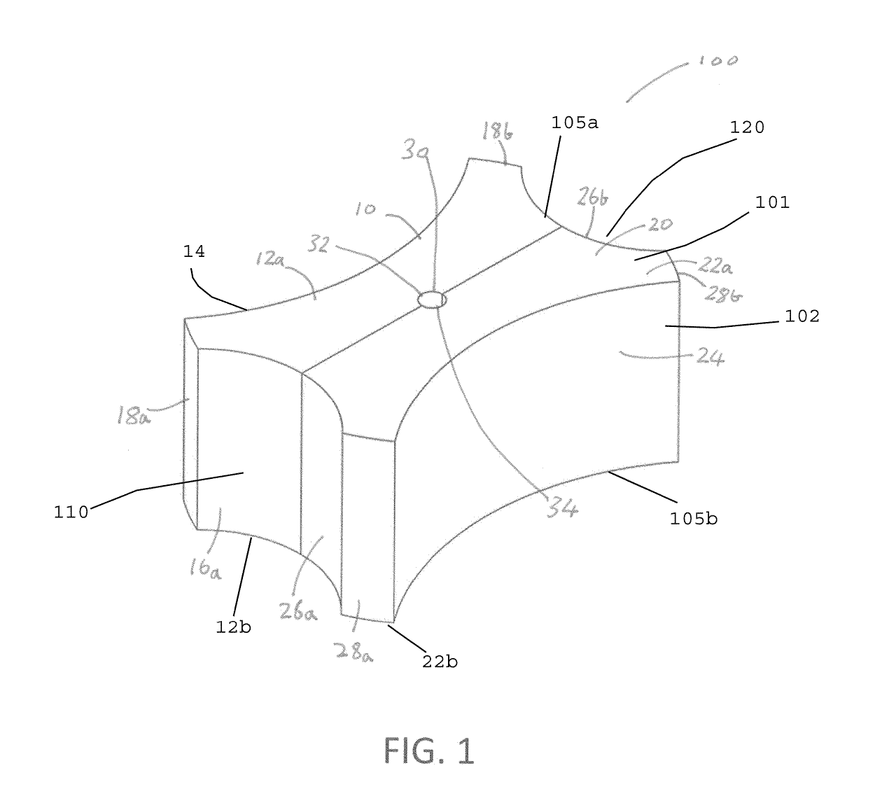

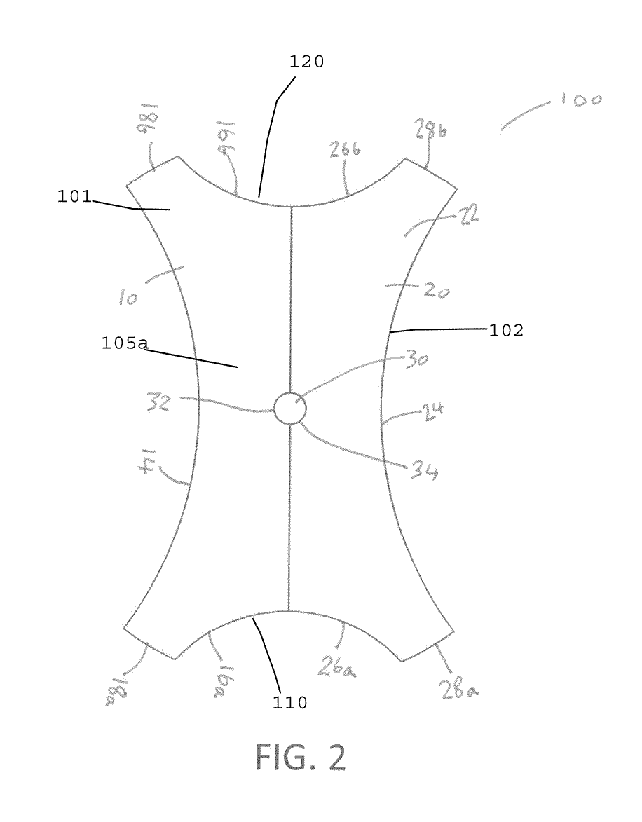

FIG. 1 is a perspective view of a plant cradle 100 according to some embodiments of the invention, and FIG. 2 is a top view of a plant cradle 100 according to some embodiments of the invention. As shown, in some embodiments, the plant cradle 100 can comprise a main body 101 that includes a series of extensions or ribs forming an outer surface 102. In some embodiments, the outer surface 102 can comprise a plurality of ridges and grooves (i.e. substantially concave surfaces). In other embodiments, the outer surface 102 can comprise a generally knurled surface. Some embodiments include a plant cradle 100 including at least one aperture 30. In some embodiments, the aperture 30 can extend through at least a portion of the plant cradle, and can be configured to hold or otherwise contain at least one seed and/or at least a portion of at least one plant. In some embodiments, the plant cradle 100 can be used to retain and support one or more plant seeds for germination and growth. In some further embodiments, the plant cradle 100 can be used to retain and support at least one plant during transportation and/or prior to transplantation. In other embodiments, the plant cradle 100 can be used to retain and support at least one plant up to or during harvesting. In some further embodiments, the plant cradle 100 can be used to support plant propagation. In some embodiments, a plant or seed can grow within a plant cradle 100 without an orifice.

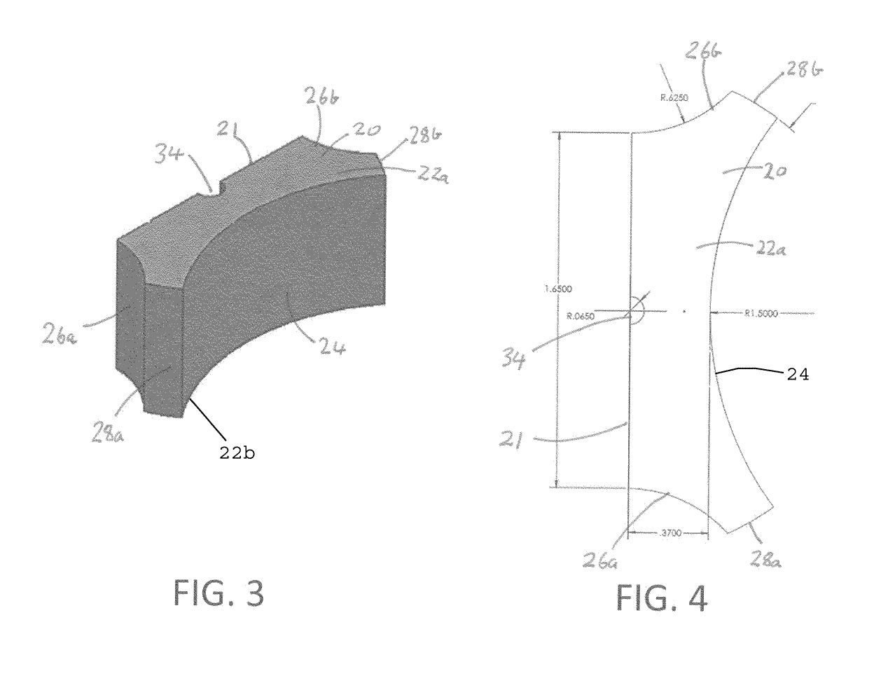

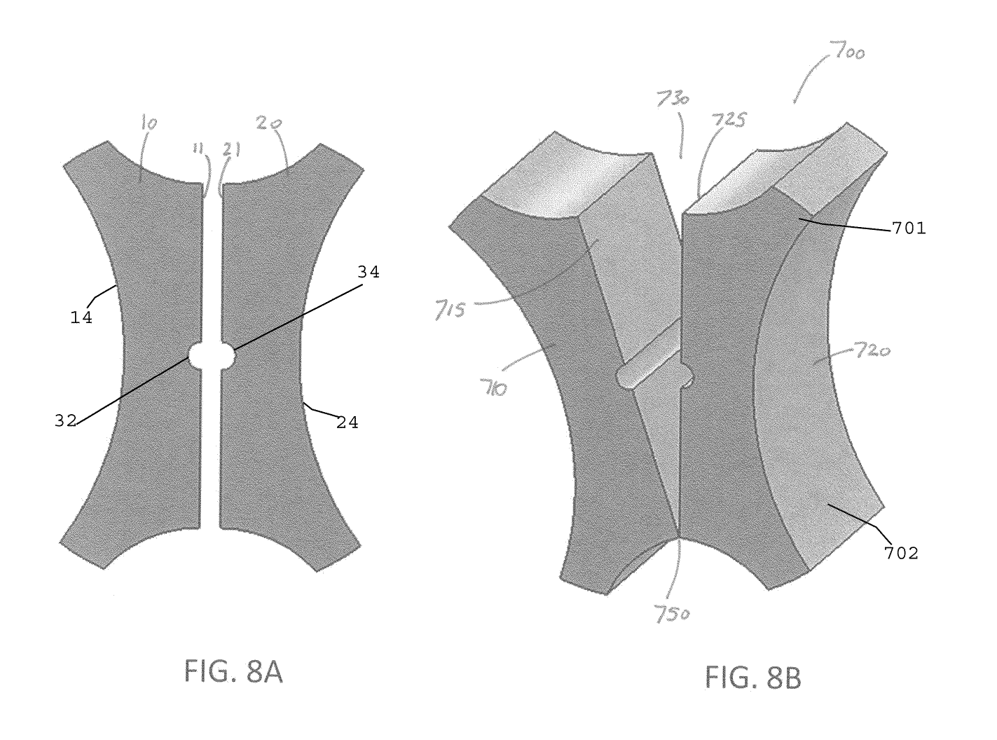

In some embodiments, the plant cradle 100 can comprise a single continuous (i.e., unitary) structure. In some embodiments, the plant cradle 100 can be segmented. In some embodiments, the plant cradle can comprise at least two portions that can be separate or coupled. For example, in some embodiments, the plant cradle 100 can comprise a main body 101 that comprises at least two portions that can comprise separate portions that can be assembled and coupled to form the plant cradle 100 (see for example FIG. 8A). In some further embodiments, the plant cradle 100 can comprise a single continuous (i.e., unitary) structure that is at least partially segmented, and can comprise at least two coupled portions that can be at pivoted with respect to each other (see for example FIG. 8B). Further, in as much as the two portions can be substantially similar or identical in size and shape, the two coupled portions can be configured and coupled together as two halves of the plant cradle 100. For example, as depicted in FIGS. 1 and 2, in some embodiments, the plant cradle 100 can comprise two coupled halves including a first half 10 and a second half 20, where the size and shape of each of the halves 10, 20 can be substantially similar or identically. FIG. 3 is a perspective view of one half of the plant cradle 100 of FIG. 1 (the second half 20) according to some embodiments of the invention, and FIG. 4 is a top perspective view of the second half 20 of the plant cradle 100 of FIG. 1 according to some embodiments of the invention.

In some embodiments, each of the halves 10, 20 forming the main body 101 can comprise top and bottoms ends, and at least one outer surface comprising one or more side and/or edge surfaces that when coupled, form the outer surface 102. For example, in some embodiments, the first half 10 can comprise a top end 12a and a bottom end 12b, and a front face 14 extending between the ends 12a, 12b. Further, each of the halves 10, 20 can comprise ends that include at least one surface. For example, in some embodiments, the first half 10 can comprise a first end surface 16a at one end and a second end surface 16b at an opposite end. Further, in some embodiments, at least one of the ends can further comprise other edges or sides that bridge between other edges or sides. Some embodiments of the invention comprise at least one bridging surface coupling one surface to another surface. For example, FIGS. 3 and 4 illustrate a second half 20 that comprises the front face 24 coupled to bridging surfaces including a first bridging side 28a and the second bridging side 28b. As shown, in some embodiments, the first bridging side 28a can extend a length between the front face 24 and the first end surface 26a that is substantially equal to the length of the second bridging surface 28b extending between the front face 24 and the second end surface 26b. In some other embodiments, the lengths of the first and second bridging sides 28a, 28b can differ (not shown).

In some embodiments, the first half 10 can comprise a first bridging side 18a at one end that is coupled to the first end surface 16a, and the front face 14. Further, in some embodiments, the opposite end can comprise a second bridging side 18b coupled to the second end surface 16b, and coupled to the front face 14. In some embodiments, the second half 20 can comprise a top end 22a and a bottom end 22b, and a front face 24 extending between the ends 22a, 22b. Further, in some embodiments, the second half 20 can comprise a first end surface 26a at one end and a second end surface 26b at an opposite end.

Further, in some embodiments, at least one of the ends can further comprise other edges or sides. For example, in some embodiments, the first half 20 can comprise a first bridging side 28a at one end, coupled to the first end surface 26a and the front face 24. Further, in some embodiments, the opposite end can comprise a second bridging side 28b coupled to the second end surface 26b and the front face 24.

In some embodiments, each halve 10, 20 can comprise a side or face that couples with a complementary side or face of an adjacent half of the plant cradle 100. For example, FIGS. 3 and 4 show the coupling face 21 of the second half 20. In some embodiments, the coupling face 21 can couple to a similar or substantially identical coupling face of the first half 10 (shown as the coupling face 11 opposing the coupling face 21 in FIG. 8A illustrating a top view of the plant cradle of FIG. 1 depicting a separation of two halves 10, 20 according to one embodiment of the invention.) In some embodiments, the coupling faces 14, 21 are of substantial equal size. In other embodiments, the coupling faces 14, 21 can be of unequal size.

In some embodiments, each half 10, 20 can comprise a coupling face that can include an open region at least partially extending into the half 10, 20, and that can extend across at least a portion of the coupling faces 14, 21. For example, in some embodiments, the first half 10 can comprise a channel 32 extending into a portion of the first half and extending across at least a portion of the coupling face 11.

In some embodiments, the channel 32 can comprise an indentation, depression, cavity, and/or a channel or conduit that is at least partially open. In some other embodiments, the channel 32 can be a closed channel or conduit (not shown). Similarly, in some embodiments, the second half 20 can comprise a channel 34 extending into a portion of the second half and extending across at least a portion of the coupling face 21. In some embodiments, the channel 34 can comprise an indentation, depression, cavity, and/or a channel or conduit that is at least partially open. In some other embodiments, the channel 34 can be a closed channel or conduit (not shown).

In some embodiments, at least one of the channels 32, 34 can comprise a substantially semi-circular cross-section. In some embodiments, at least one of the channels 32, 34 can extend across a substantial portion of the plant cradle 100 from the top end 12a, 22a to the bottom end 12b, 22b. Further, in some embodiments, any one of the channels 32, 34 can extend from the top end 12a, 22a to the bottom end 12b, 22b. For example, in some embodiments channel 32 can extend from the top end 12a to the bottom end 12b of the first half 10. Further, in some embodiments, channel 34 can extend from the top end 22a to the bottom end 22b of the second half 20. In some embodiments, the channels 32, 34 may not extend completely across the coupling faces 14, 21 respectively. Further, in some embodiments, both channels 32, 34 do not extend through the bottom ends 12b, 22b respectively. In this instance, the channel can form a closed-end cavity that does not extend from the top end 105a of the plant cradle and bottom end of the plant cradle 105b.

In some embodiments of the invention, the plant cradle 100 can be formed by coupling the coupling face 11 of the first half 10 with the coupling face 21 of the second half 20. Further, in some embodiments, each half 10, 20 can be substantially aligned by coupling the respective coupling faces 14, 21 so that substantially all of the surfaces of the coupling faces 14, 21 are coupled. Further, the coupling faces 14, 21 can be positioned with respect to each other so that the channels 32, 34 are at least partially aligned. In this instance, at least some portion of the channels 32, 34 can form at least a portion of the aperture 30 in some embodiments.

In some embodiments, the aperture 30 can comprise a cross-section that is substantially circular. For example, in some embodiments, when the cross-section of channels 32, 34 is substantially semi-circular, and the first half 10 and second half 20 are coupled by aligning and coupling the coupling face 11 of the first half 10 with the coupling face 20 of the second half 20, a plant cradle 100 can be formed including at least one channel (formed by the aperture 30) that comprises a substantially circular cross-section. In some embodiments, the aperture 30 can extend from the top end 105a of the plant cradle 100 and through the plant cradle 100 to a bottom end 105b of the plant cradle. The example embodiment of the second half 20 shown in FIGS. 2 and 3 includes a view showing a channel 34 (extending to and through the top end 22a) and the plant cradle 100 shown in FIG. 1 includes a perspective view showing one end of the aperture 30 extending to and through the top end 105a of the plant cradle 100. In some embodiments, the cross-section of any portion of the channel can be substantially non-circular. For example, in some embodiments, the cross-section of any portion of the channel can comprise a square, rectangular, or trapezoidal-shaped channel.

In some embodiments, the channels 32, 34 can be positioned substantial mid-way across the width of the coupling faces 14, 21 respectively so that the aperture 30 can be formed in the substantial center of the plant cradle 100 when the halves 10, 20 are positioned and aligned so that the channels 32, 34 are substantially aligned. In some other embodiments, the aperture 30 can be positioned off-center. For example, in some embodiments the channels 32, 34 can be positioned closer to either of the ends of the halves 10, 20 and aligned so that the channel 30 is positioned substantially off-center and closer to one end of the plant cradle 100 than the opposite end of the plant cradle 100.

In some further embodiments, the plant cradle 100 can include more than one channel 30. In some embodiments, the plant cradle 100 can comprise a plurality of channels 30. In some embodiments, the plant cradle 100 can comprise a plurality of channels 30 that can be evenly or unevenly distributed across the plant cradle 100. In some embodiments the plurality of channels 30 can extend through the plant cradle 100 from the top end to the bottom end. In other embodiments, at least one of a plurality of channels can extend partially from a top end towards a bottom end of the plant cradle 100, but may not extend to the bottom end. In this instance, a channel can form a cavity from the top end, extending part-way through the plant cradle 100.

In some embodiments, the plant cradle 100 can comprise a plurality of connected channels. In some embodiments, at least one channel extending from one end of the plant cradle 100 (such as the top end 105a) can be fluidly coupled with at least one other channel extending to an opposite end of the plant cradle 100 (such as bottom end 105b). For example, in some embodiments, one or more channels 30 can extend from a top end 105a of the plant cradle 100 and can fluidly couple with each other and extend through to the opposite end of the plant cradle 100 (bottom end 105b). In some other embodiments, the plant cradle 100 can comprise at least one channel 30 that extends from one end of the plant cradle 100 (such as top end 105a) and fluidly couples with two or more channels extending to an opposite end (e.g., one channel can bifurcate into two channels extending towards the opposite end, including for example the bottom end 105b).

In some embodiments of the invention, either of the front faces 14, 24 can be substantially flat, and substantially parallel with coupling faces 11, 21 respectively. In some other embodiments, either of the front faces 14, 24 can comprise a curved surface. For example, in some embodiments, the front face 14 of the first half 10 can comprise a substantially concave surface. In some other embodiments, the front face 14 can be substantially convex (not shown). In other embodiments, the front face 14 can comprise portions that are concave and/or convex (not shown). Similarly, in some embodiments, the front face 24 of the second half 20 can comprise a substantially concave surface. In some other embodiments, the front face 24 can be substantially convex (not shown). In other embodiments, the front face 24 can comprise portions that are concave and/or convex (not shown).

In some embodiments of the invention, any one of the halves 10, 20 can include additional curved surfaces. For example, in some embodiments, the first half 10 can comprise a first end surface 16a that comprises a substantially curved surface. Further, in some embodiments, the first end surface 16a comprises a substantially concave surface. In some further embodiments, the first half 10 can comprise a second end surface 16b that comprises a substantially curved surface. Further, in some embodiments, the second end surface 16b comprises a substantially concave surface. Similarly, in some embodiments, the second half 20 can comprise a first end surface 26a that comprises a substantially curved surface. Further, in some embodiments, the first end surface 26a comprises a substantially concave surface. In some further embodiments, the second half 20 can comprise a second end surface 26b that comprises a substantially curved surface. Further, in some embodiments, the second end surface 26b comprises a substantially concave surface.

In some embodiments of the invention, any one of the halves 10, 20 can include other surfaces that comprise a curved surface. For example, in some embodiments, the first half 10 can comprise a first bridging side 18a at one end that comprises a substantially curved surface coupled to the first end surface 16a and the front face 14. Further, in some embodiments, the second bridging side 18b can comprise a substantially curved surface coupled to the second end surface 16b and coupled to the front face 14. In some embodiments, either of the sides 18a, 18b can comprise a substantially convex surface. In other embodiments, either of the sides 18a, 18b can comprise a substantially concave surface. Similarly, in some embodiments, the second half 20 can comprise a first bridging side 28a at one end that comprises a substantially curved surface coupled to the first end surface 26a and the front face 24. Further, in some embodiments, the second bridging side 28b can comprise a substantially curved surface coupled to the second end surface 26b and coupled to the front face 24. In some embodiments, either of the sides 28a, 28b can comprise a substantially convex surface. In other embodiments, either of the sides 28a, 28b can comprise a substantially concave surface.

Turning to FIGS. 1 and 2, in some embodiments of the invention, by coupling halves 10, 20, the plant cradle 100 can include a first end 110 comprising the first end surfaces 16a, 26a and a second end 120 comprising second end surfaces 16b, 26b. In some embodiments, the first end surfaces 16a, 26a and the second end surfaces 16b, 26b can each comprise a substantially contiguous surface. Further, in some embodiments, any one of the surfaces comprising coupled first end surfaces 16a, 26a and second end surfaces 16b, 26b can comprise a substantially concave surface. In some other embodiments, any one of the surfaces comprising coupled first end surfaces 16a, 26a and second end surfaces 16b, 26b can comprise a substantially flat surface or a substantially convex surface (not shown).

In some embodiments, any of the sides of the plant cradle 100 can comprise a concave side that is different between the two halves 10, 20. For example, in some embodiments, the first end surfaces 16a, 26a and second end surfaces 16b, 26b can each comprise a concave surface with a different radius of curvature. Further, in some embodiments, the coupled first end surfaces 16a, 26a and second end surfaces 16b, 26b in the plant cradle 100 can each comprise a concave surface with a different radius of curvature. In some other embodiments, the first end surfaces 16a, 26a and second end surfaces 16b, 26b can comprise radii of curvature that are substantially the same. In some further embodiments, any of the front face 14, 24 can comprise concave surfaces that include substantially the same radius of curvature. In other embodiments, any of the front faces 14, 24 can comprise concave surfaces that include a different radii of curvature.

In some embodiments, alignment and coupling of halves 10, 20 of substantially equal size and shape can form a plant cradle 100 that comprises four concave surfaces coupled with four bridging surfaces as shown in FIGS. 1 and 2. In some embodiments, the radius of curvature of each of the four concave surfaces can be substantially the same. In some other embodiments, the radius of curvature of each of the four concave surfaces can be different. In some further embodiments, the radius of curvature of two of the four concave surfaces can be different with the radius of curvature of two surfaces on two opposite side being substantially the same.

Some embodiments including bridging surfaces that include a radius of curvature. For example, in some embodiments, one or more of the bridging sides 18a, 18b, 28a, 28b of the plant cradle 100 shown in FIGS. 1 and 2 can include surfaces that are convex. In some other embodiments, the bridging sides 18a, 18b, 28a, 28b do not include a radius of curvature and are not concave or convex.

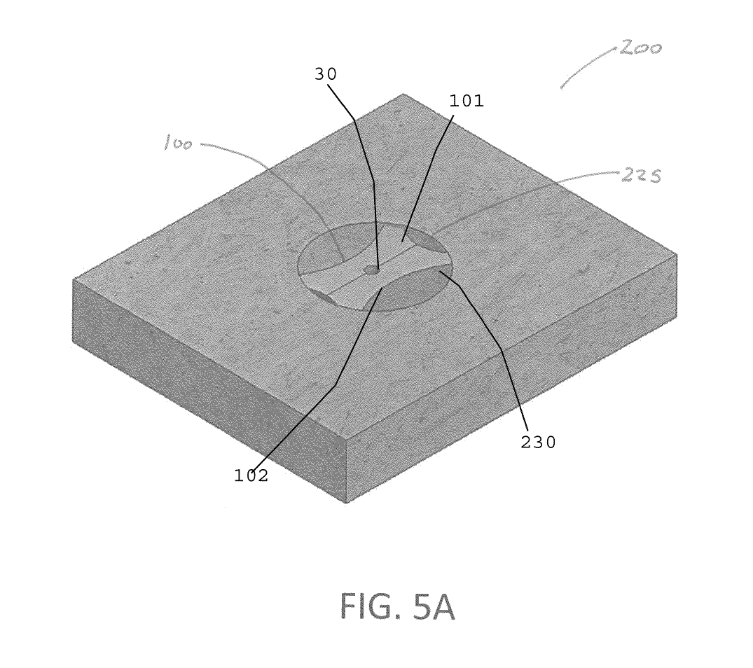

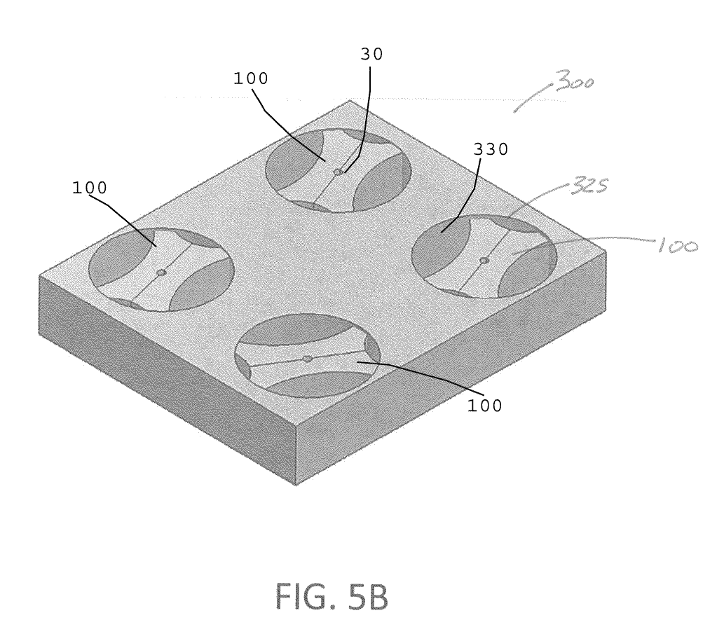

In some embodiments of the invention, the plant cradle 100 can be coupled to a growing platform or raft. For example, FIG. 5A illustrates a perspective view of a growing platform 200 shown supporting a plant cradle 100 according to some embodiments of the invention, and FIG. 5B illustrates a perspective view of a growing platform 300 shown supporting multiple plant cradles 100 according to some embodiments of the invention. As shown in FIG. 5A, the growing platform 200 can comprise a single cradle aperture 225 that is capable of retaining and/or supporting a plant cradle 100. The illustrated embodiment comprises a substantially circular cradle aperture 225, and a plant cradle 100 supported in the aperture 225. Other embodiments can include one or more cradle apertures 225 with different size or shape to enable retention and support of plant cradles 100 with variations in size or shape.

In some embodiments, the halves 10, 20 of a plant cradle 100 can comprise a material that is flexible and/or compressible. For example, in some embodiments, halves 10, 20 can comprise flexible polymer foam. In some embodiments, the plant cradle 100 can comprise polyethylene-based foam (e.g., extruded polyethylene-based foam). In some other embodiments, the plant cradle 100 can comprise polyurethane-based foam, polyether-based foam, polypropylene-based foam, polystyrene-based foam, polymethacrylimide-based foam, polyvinylchloride-based foam, rubber-based foam, or mixtures thereof.

In some embodiments, the halves 10, 20 of a plant cradle 100 can comprise a material that is biodegradable. In some embodiments, the halves 10, 20 of a plant cradle 100 can comprise a cellulosic-based polymer or other naturally-derived material. For example, in some embodiments, the halves 10, 20 of a plant cradle 100 can comprise a plant-based material or plant-based composite. In some embodiments, the plant-based material or composite can comprise cellulosic fiber and/or starch fiber and/or plant residue and/or plant waste fibers derived from trees, grasses, shrubs, and the like. In some other embodiments, the halves 10, 20 of a plant cradle 100 can comprise a polymer or copolymer derived from a plurality of plant oil-derived monomers. In some other embodiments, the halves 10, 20 of a plant cradle 100 can comprise a synthetic polymer mixed with a plant-based material. For example, some embodiments can include any of the synthetic polymers or copolymers described earlier that are mixed with one or more plant-derived cellulosic fibers and/or starch fibers and/or plant residue and/or plant waste fibers.

In some embodiments, the foam can comprise an open, substantially interconnected porosity. In other embodiments, the foam can comprise a closed, substantially non-interconnected porosity. In some embodiments, the use of a lightweight material to replace traditional net pots with stones located in the adjacent growing platforms can reduce the overall weight to 1/25th of the weight of the stone-filled net pots. In some other embodiments, the portions can comprise a polymer-based fiber, polymer-based mesh, polymer-based weave, or polymer-based mat. In other embodiments, the portions can comprise a combination of polymer-based foam and a fiber, such as a polymer-based fiber.

In some embodiments, the plant cradle 100 can be positioned into a cavity (i.e. an aperture in a growing platform). In some embodiments, the plant cradle 100 can be positioned into a cavity by compression of at least a portion of the plant cradle 100 into a cavity. In some embodiments, cavities can comprise a diameter of about 1⅞″ or 2″, and the plant cradle 100 can fit in either size of cavity (i.e., in the case of a 1⅞″ diameter cavity, the plant cradle 100 will be more compressed than in the case of a 2″ diameter cavity). One of ordinary skill in the art will recognize that the plant cradle 100 can be designed to fit snugly into apertures that comprise a diameter that is less than 1⅞″ or greater than 2″. Moreover, in some embodiments, the apertures can be larger, for example, in some embodiments the apertures can exceed 2″.

In some embodiments, the plant cradle 100 can be coupled to the internal surface 230 of the cradle aperture 225. In some embodiments, any of the surfaces or sides of the plant cradle 100 can couple with the internal surface 230. For example, in some embodiments of the invention, any of the bridging sides 18a, 28a of the first end 110 of the plant cradle 100 and/or any of the bridging sides 18b, 28b of the second end 120 of the plant cradle 100 can couple with the internal surface 230 of the cradle aperture 225. In some embodiments of the invention, any of the bridging sides 18a, 28a of the first end 110 of the plant cradle 100 and/or any of the bridging sides 18b, 28b of the second end 120 of the plant cradle 100 can comprise convex surfaces with a radius of curvature that is substantially complementary to at least a portion of the radius of curvature of the cradle aperture 225. In some other embodiments, any of the bridging sides 18a, 28a of the first end 110 of the plant cradle 100 and/or any of the bridging sides 18b, 28b of the second end 120 of the plant cradle 100 the bridging surfaces can comprise surfaces with a radius of curvature that is not complementary to at least a portion of the radius of curvature of the cradle aperture 225. In some embodiments, the growing platform 200 and the plant cradle 100 can be configured to enable a desirable combination of contact resistance within the growth platform 200 using any of the bridging sides 18a, 28a of the first end 110 of the plant cradle 100 and/or any of the bridging sides 18b, 28b of the second end 120 of the plant cradle 100, while any surfaces such as the first and second end surfaces 16a, 16b, and/or the first and second end surfaces 16a, 16b, and/or the front face 14 and/or front face 24 that comprise a concave surface can enable the material volume and mass of the plant cradle 100 to be minimized.

Turning now to FIG. 5B, some embodiments can include a plurality of plant cradles 100 distributed within a growing platform 300. In some embodiments, multiple plant cradles 100 can be substantially evenly spaced apart within a growing platform 300. In other embodiments, multiple plant cradles 100 can be distributed randomly within the growing platform and can be unevenly spaced. In some embodiments, the plant cradle 100 can be coupled to the internal surface 330 of the cradle aperture 325.

In some embodiments, any of the surfaces or sides of the plant cradle 100 can couple with the internal surface 330. For example, in some embodiments of the invention, any of the bridging sides 18a, 28a of the first end 110 of the plant cradle 100 and/or any of the bridging sides 18b, 28b of the second end 120 of the plant cradle 100 can couple with the internal surface 330 of the cradle aperture 325. In some embodiments of the invention, any of the bridging sides 18a, 28a of the first end 110 of the plant cradle 100 and/or any of the bridging sides 18b, 28b of the second end 120 of the plant cradle 100 can comprise convex surfaces with a radius of curvature that can be substantially complementary to at least a portion of the radius of curvature of the cradle aperture 325. In some other embodiments, any of the bridging sides 18a, 28a of the first end 110 of the plant cradle 100 and/or any of the bridging sides 18b, 28b of the second end 120 of the plant cradle 100 the bridging surfaces can comprise surfaces with a radius of curvature that is not complementary to at least a portion of the radius of curvature of the cradle aperture 325.

In some embodiments, growing platform 300 and the plant cradle 100 can be configured to enable a desirable combination of contact resistance within the growth platform 300 using any of the bridging sides 18a, 28a of the first end 110 of the plant cradle 100 and/or any of the bridging sides 18b, 28b of the second end 120 of the plant cradle 100, while any surfaces such as the first and second end surfaces 16a, 16b, and/or the first and second end surfaces 16a, 16b, and/or the front face 14 and/or front face 24 that comprise a concave surface can enable the material volume and mass of the plant cradle 100 to be minimized.

In some embodiments, the aperture 30 within the plant cradle 100 can be used to support a plant seed. For example, in some embodiments, a seed can be placed into the aperture 30 within the plant cradle 100. In some embodiments, the aperture 30 within the plant cradle 100 can be used to support an un-germinated plant seed. In some other embodiments, the seed can be germinated outside of the plant cradle 100, and then transplanted to the plant cradle 100 aperture 30. Further, some embodiments of the invention include methods of use of one or more plant cradles 100 to germinate, raise, and harvest a plant.

Some seeds can include a coating. For example, in some embodiments, the seed can include a polymer coating that controls dust emission during seed handling and planting, or can be used to control flow and coverage during planting. In some embodiments, the coating can include colorants or other additives, such as bio-fungicides or bio-insecticides. Some coatings can comprise a combination of additives including polymers, colorants and other additives. In some other embodiments, the aperture 30 can comprise a pre-loaded coating, colorant, or other additives.

In some embodiments, the flexibility and compliance of the plant cradle 100 can enable the plant cradle 100 to expand internally (i.e. outwardly from the center of the aperture 30) as the seed swells during the germination process, and as the plant grows out of the seed structure. For example, in some embodiments, as a plant stalk is formed and increases in diameter, the plant cradle 100 cavity can substantially surround the stalk, and expand in diameter as the diameter of the stalk increases. Moreover, as the base of the plant grows, the foam can be able to flex enough to give the stalk some room, but still hold firm against it to prevent it from tipping.

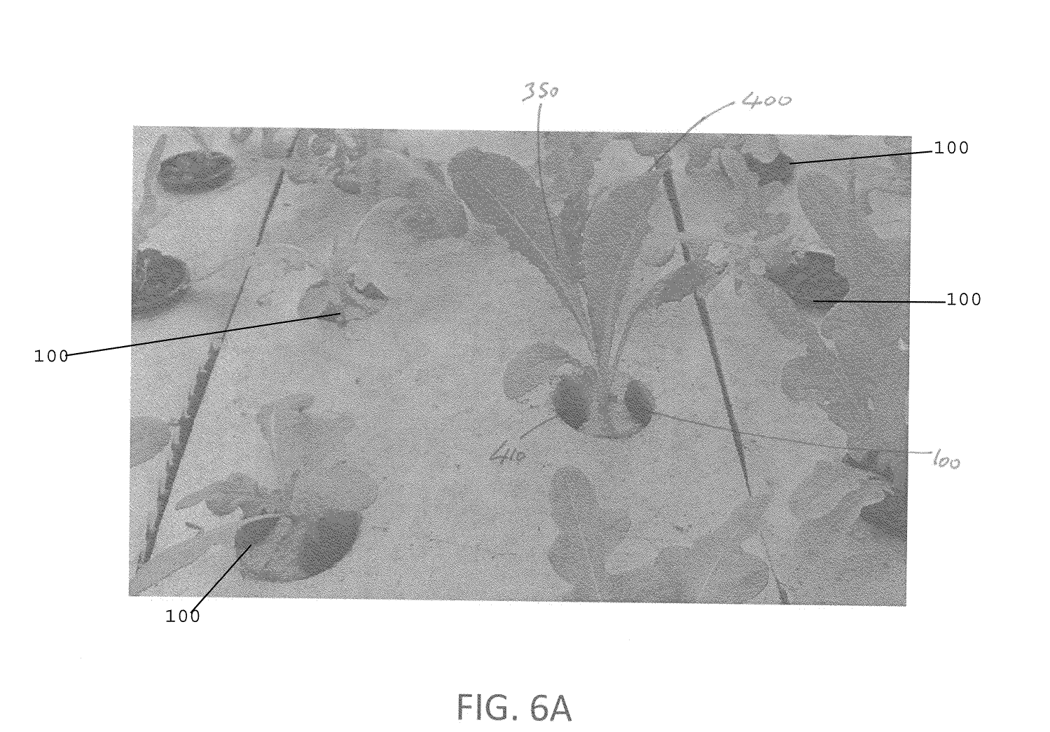

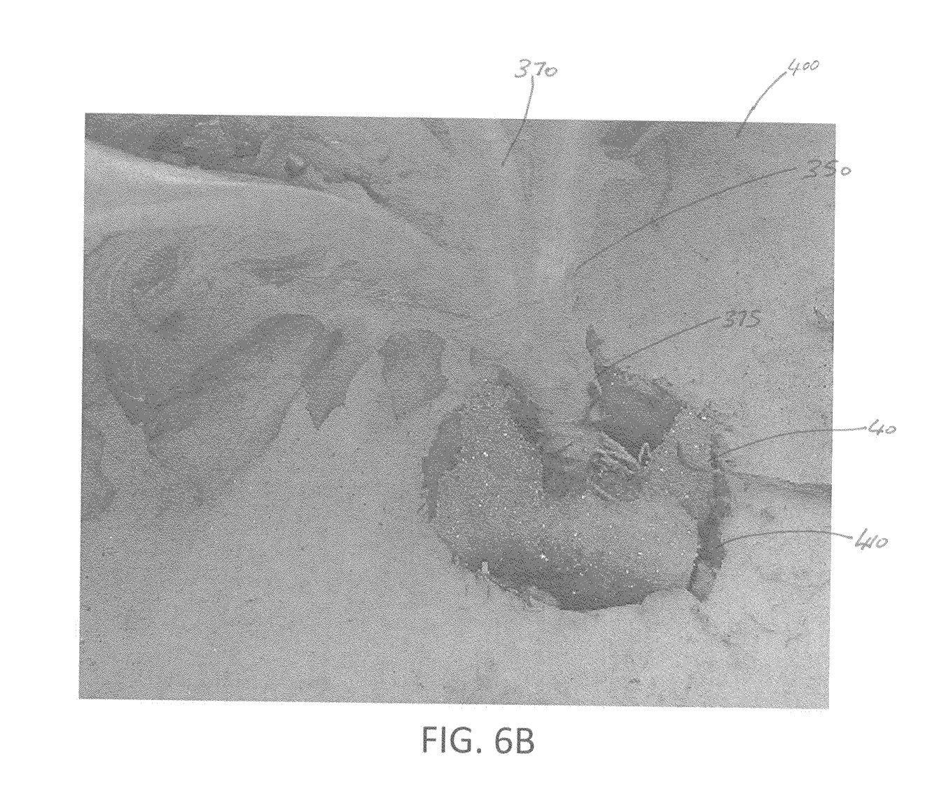

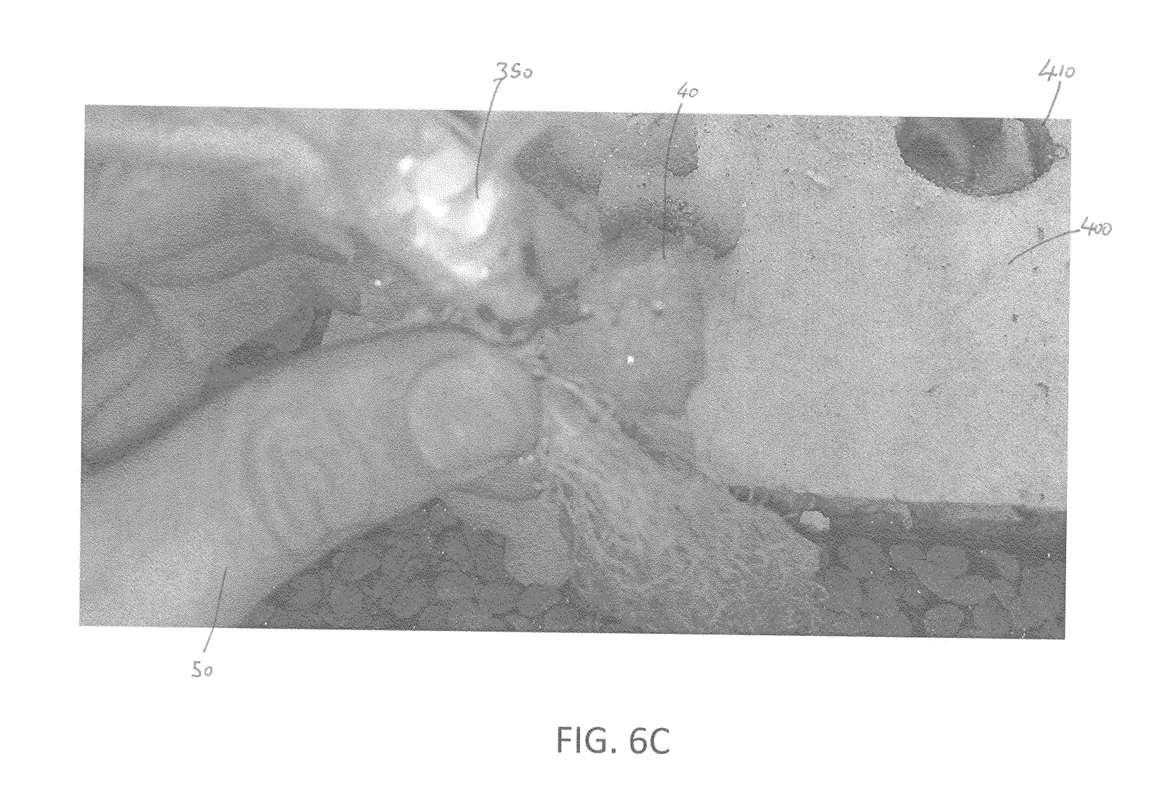

In some embodiments, each plant cradle 100 can support at least one plant. In some embodiments, a plurality of plant cradles 100 can be distributed within a growing platform. For example, FIG. 6A illustrates a perspective view of growing platform 400 including a plurality of plant cradles 100 according to some embodiments of the invention. In some embodiments, the growing platform 400 can comprise a floating raft comprising a plurality of through cavities (cradle apertures 410). As described earlier, the cradle apertures 410 can be used to retain plant cradles 100. In some embodiments, the use of cradle apertures 410 that comprise through cavities can enable moisture and nutrients to move into the plant cradles 100 through capillary or other action. Further, plant roots can extend through the plant cradle 100 and below the growing platform 400. Moreover, the use of plant cradles 100 with concave surfaces can allow a greater surface area for moisture to be absorbed from the water surface below the platform (due to greater surface area exposed to the moisture).

In some embodiments, a plant 350, either originally seeded into one or more of the plurality of plant cradles and/or transplanted as a germinated juvenile plant can mature within the plant cradle 100 to a size suitable deemed suitable for harvesting. For example, FIG. 6B is a close-up perspective view of a plant cradle 100 with a plant 350 positioned within a growing platform 400 according to some embodiments of the invention. As described earlier and as illustrated in FIG. 6B, the plant stem 375 can develop and increase in diameter as the plant 350 matures, and as the plant cradle 100 expands. As depicted, in some embodiments, the plant cradle 100 can substantially surround the plant stem 375. In some embodiments, the plant roots 360 can extend beneath the growing platform 400, and the plant leaf sections 370 can extend away from the platform 400 on an opposite side of the growing platform 400. In some further embodiments, some portions of the plant 350 can extend above or below the platform 400. For example, in some embodiments, at least some portion of the plant leaf sections 370 and/or at least some portions of the plant stem 375 can extend into the cradle aperture 410. Further, in some embodiments, during a maturation of the plant 350, and/or during removal of the plant 350 or plant cradle 100 form the cradle aperture 410, some sections or portions of the plant cradle can decay or otherwise exit the cradle aperture, and some portions (shown as 40) can remain in the cradle aperture 410.

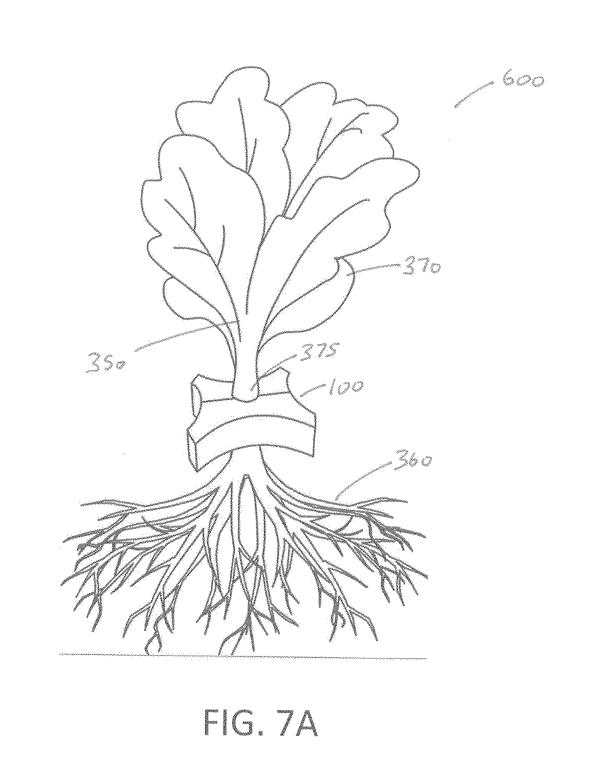

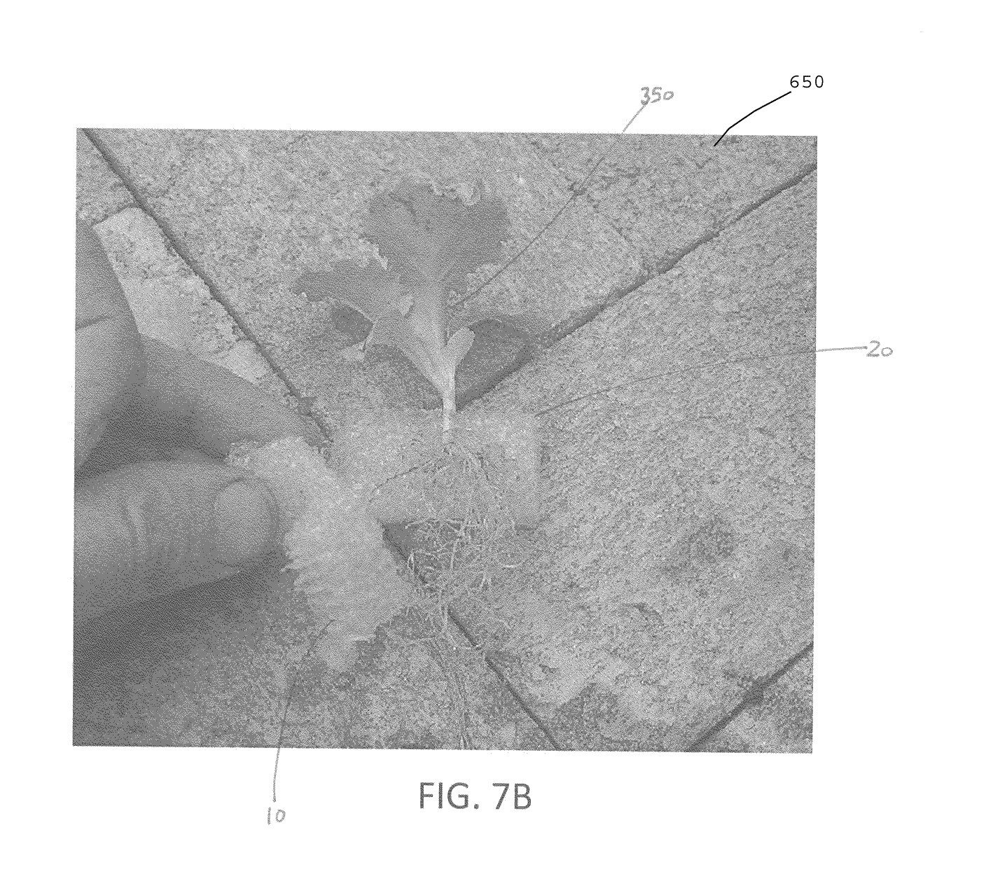

In some embodiments, the plant can be harvested from the growth platform 400. As shown in FIG. 6C, showing a close-up view of a plant 350 removed from a growing platform 400 and at least partially separated from a plant cradle 100 according to one embodiment of the invention. Further, FIG. 7A is a front perspective view 600 of a plant 350 and plant cradle 100 removed from a growing platform according to some embodiments of the invention, and FIG. 7B is close-up view 650 of a plant 350 removed from a growing platform 400 with one half of a plant cradle 100 separated (showing the two halves 10, 20) according to one embodiment of the invention. In some embodiments, when removing the plants, the plant 350 and plant cradle 100 can be removed from the growing platform, and the plants can be separated from the two halves 10, 20 of the plant cradle 100. For example, the separation of portions (i.e. two halves 10, 20) of the plant cradle 100 can be further illustrated in FIG. 8A illustrating a top view of the plant cradle of FIG. 1 depicting a separation of two halves 10, 20 according to one embodiment of the invention. In some embodiments, the two halves 10, 20 may not separate uniformly. For example, in some embodiments, portions of the two halves 10, 20 can become forcibly joined due to a variety of factors including for example ingrowth of plant roots 360, and/or deposition of salts or other water-borne materials. In those instances, portions 40 of at least one of the two halves 10, 20 can remain coupled to the plant 350 and/or portions 40 can be forcibly removed. For example, in some instances, the halves 10, 20 can simply fall away from the plant 350. In some other instances, a grower can peel away one or both halves 10, 20 from the plant stem 375 and/or plant roots 360. In some embodiments, the plant roots 360 can stay on the plant, and they can be either cut off or kept with the plant 350 (the latter depicted in FIG. 7A).

In some embodiments, the plant cradle 100 can be reused. In some embodiments, the plant cradle halves 10, 20 or portions 40 (shown for example in FIGS. 6C and 7B) as separated, can be collected and reused within a growth platform. For example, in some embodiments, used halves 10, 20 or portions 40 can be collected and used directly for plant germination or for plant growth using germinated seeds or seedlings. In some embodiments, the portions can be rinsed to remove debris and stored for reuse.

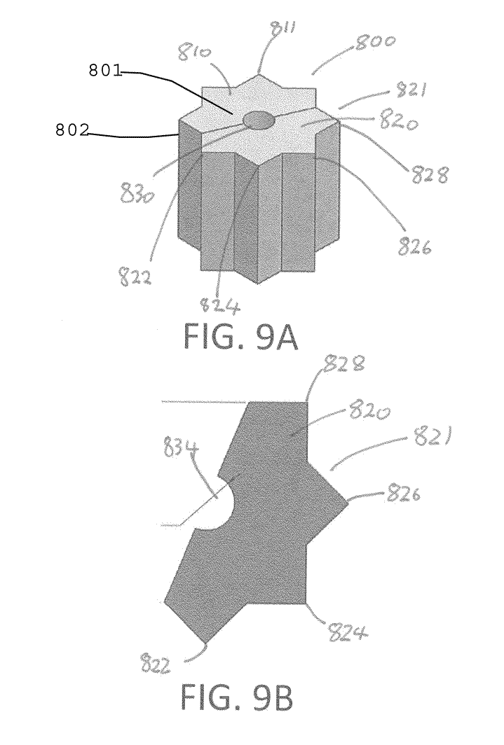

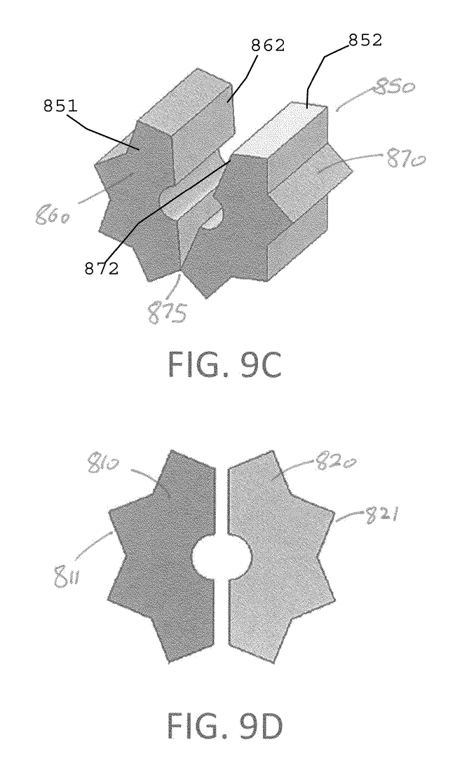

Some embodiments of the invention can include a plant cradle that comprises at least two portions that are coupled and can extend away from another while coupled. For example some embodiments of the invention can include at least one portion that is hinged and configured to rotate away from at least one other portion. Using this configuration can enhance the ability of a user to readily open the plant cradle to add a young plant or seed and/or to access one or more matured plants. Further, in some embodiments, the use of this configuration can enable the plant cradle to be reused after an initial or subsequent use. For example, as shown in FIGS. 8B and 9C, in some embodiments, the plant cradle 100 can be hinged at one end to enable two portions to be separated about a pivot point. In some embodiments, portions can be readily reused and closed to form a plant cradle for another plant or seed. FIG. 8B illustrates a perspective view of the plant cradle 700 (comprising a hinged embodiment of the plant cradle 100) depicting a two hinged halves forming a main body 701 comprising a first hinged half 710 and a second hinged half 720 joined by a hinge section 750. In some embodiments, the first hinged half 710 can comprise a coupling face 715, and the second hinged half 720 can comprise a coupling face 725. In some embodiments, the halves 710, 720 can be pivoted towards each other, and in other embodiments, the halves 710, 720 can be hinged away from each other while remaining coupled by the hinge section 750. In some embodiments, the first hinged half 710 be coupled to the second hinged half 720 by pivoting each half 710, 720 so that the coupling face 715 is proximate the coupling face 725. In some embodiments, the first hinged half 710 be coupled to the second hinged half 720 by pivoting each half 710, 720 so that the coupling face 715 is coupled to the coupling face 725. In some further embodiments, the first hinged half 710 can be decoupled from the second hinged half 720 by pivoting each half 710, 720 so that the coupling face 715 is pivoted away from the coupling face 725. Further, as shown, in some embodiments, the plant cradle 700 can comprise a main body 701 that includes a series of extensions or ribs forming an outer surface 702 that comprises a plurality of ridges and grooves. In other embodiments, the outer surface 702 can comprise a generally knurled surface.

Some embodiments of the invention can include alternative plant cradle shapes and geometries. For example, FIG. 9A is a perspective view of a plant cradle 800 according to another embodiment of the invention, and FIG. 9B is a top view of one half of the plant cradle 800 of FIG. 9A according to some embodiments of the invention. As shown, in some embodiments, the plant cradle 800 can comprise a main body 801 that includes a series of extensions or ribs forming an outer surface 802 that comprises a plurality of ridges and grooves. In other embodiments, the outer surface 802 can comprise a generally knurled surface. In some embodiments, when inserted in a growing platform or other holder, the ridges can form contact points with the inner surface of the growing platform. In some embodiments, one or more of the extensions can at least partially compress and provide a friction fit with an inner surface of an aperture of an aperture in a growth platform. For example, in some embodiments, the plant cradle 800 can comprise a first half 810 comprising a plurality of extensions 811, and a second half 820 comprising a plurality of extensions 821. As shown in FIG. 9B showing one half (e.g., the second half 820), in some embodiments, the plant cradle 800 can comprise a first extension 822, and/or a second extension 824, and/or a third extension 826, and/or fourth extension 828. Further, the first half 810 can be substantially identical to the second half 820). Further, in some embodiments, the second half 820 can comprise a second half channel 834 that when coupled to a first half 810 can form the aperture 830 (shown in FIG. 9A).

FIG. 9C illustrates a perspective view of the hinged embodiment (shown as 850) of the plant cradle 800 of FIG. 9A, and FIG. 9D illustrates a top view of the plant cradle 800 of FIG. 9A depicting a separation of two portions according to one other embodiment of the invention (i.e., represented an unhinged version of the plant cradle 800). In some embodiments, the plant cradle 850 can comprise a main body 851 that includes a series of extensions or ribs forming an outer surface 852 that comprises a plurality of ridges and grooves. In other embodiments, the outer surface 852 can comprise a generally knurled surface. In this illustrated embodiment, the first half 860 comprises a hinged embodiment of the first half 810, and the second half 870 comprises a hinged embodiment of the second half 820 of the plant cradle 800. Similar to the hinged embodiment of the plant cradle 100, in some embodiments, the first hinged half 860 can comprise a coupling face 862, and the second hinged half 870 can comprise a coupling face 872. In some embodiments, the halves 860, 870 can be pivoted towards each other, and in other embodiments, the halves 860, 870 can be hinged away from each other while remaining coupled by the hinge section 875. In some embodiments, the first hinged half 860 be coupled to the second hinged half 870 by pivoting each half 860, 870 so that the coupling face 862 is proximate the coupling face 872. In some embodiments, the first hinged half 860 be coupled to the second hinged half 870 by pivoting each half 860, 870 so that the coupling face 862 is coupled to the coupling face 872. In some further embodiments, the first hinged half 860 can be decoupled from the second hinged half 870 by pivoting each half 860, 870 so that the coupling face 862 is pivoted away from the coupling face 872.

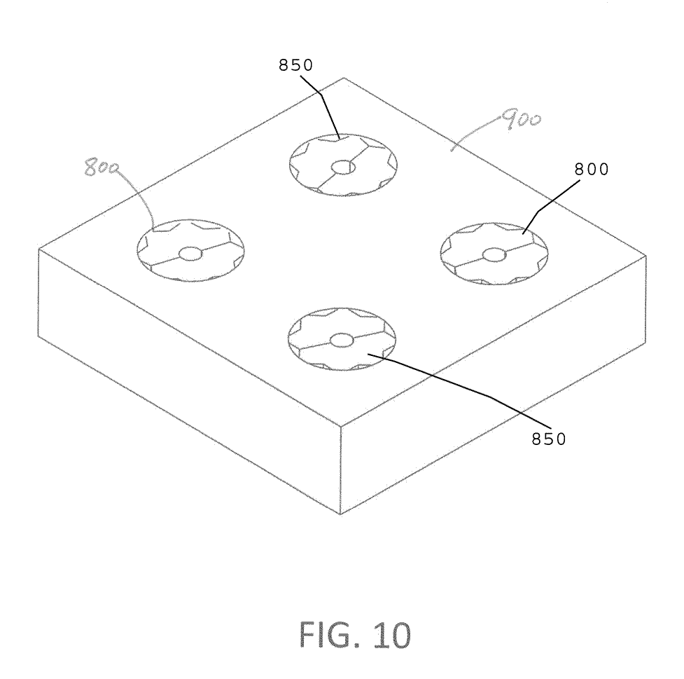

In some embodiments, a plurality of plant cradles 800 and/or plant cradles 850 can be distributed within a growing platform. FIG. 10 illustrates a perspective view of a growing platform 900 including multiple plant cradles 800, 850 according to some embodiments of the invention. As illustrated, the growing platform 900 can comprise a plurality of cradle apertures 910, any one of which can be used to retain and/or support plant cradles 800, 850. Further, the number of plant cradles 800, 850 and the distribution of plant cradles 800 and/or plant cradles 850 need not be limited to the embodiments shown. Moreover, the number of plant cradles 800 and/or plant cradles 850 can be a function of the availability of cradle apertures 910 within the growing platform. Further, one of ordinary skill in the art will recognize that various types of plant cradles can be positioned together on the same growing platform. For example, in some embodiments, a growing platform with cradle apertures 910, and/or cradle apertures 225, and/or cradle apertures 325 can be used to accommodate plant cradles 100, 700, 800, 850 within the same growing platform.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A plant cradle comprising:
a segmented main body including a first end and a second end and comprising at least one portion pivotable with respect to another portion;
an outer surface extending from the first end to the second end, the outer surface comprising at least one ridge adjacent at least one first surface;
at least one aperture extending at least partially through the segmented main body from the first end towards the second end and configured and arranged to hold a plant; and
at least one hinge section coupled to the portions, the at least one hinge section configured to enable the two portions to be pivoted with respect to each other about the at least one hinge section.

2. The plant cradle of claim 1, wherein the portions comprise a first half and a second half

3. The plant cradle of claim 2, wherein the first half is shaped substantially identically to the second half

4. The plant cradle of claim 2, wherein the first half and the second half are dissimilarly shaped.

5. The plant cradle of claim 1, wherein the at least one first surface comprises a substantially concave surface.

6. The plant cradle of claim 1, wherein the segmented main body comprises a polymer.

7. The plant cradle of claim 6, wherein the polymer comprises a polyethylene-based foamed polymer.

8. The plant cradle of claim 6, wherein the polymer comprises at least one of a polyethylene polymer, polyurethane-based foamed polymer, a polyether-based foamed polymer, a polypropylene-based foamed polymer, a polystyrene-based foamed polymer, a polymethacrylimide-based foamed polymer, a polyvinylchloride-base foamed polymer, a rubber-based foamed polymer, a cellulosic-based polymer, plant-derived cellulosic fibers, plant-oil derived polymer, and mixtures thereof.

9. The plant cradle of claim 1, wherein the segmented main body comprises at least one of a polymer fiber, polymer mesh, polymer weave, and polymer mat.

10. The plant cradle of claim 2, wherein the at least one aperture is positioned in the first half.

11. The plant cradle of claim 2, wherein the at least one aperture is positioned in the second half.

12. The plant cradle of claim 2, wherein at least a portion of the at least one aperture extends through at least a portion of the first half and at least a portion of the at least one aperture extends through at least a portion of the second half.

13. The plant cradle of claim 1, wherein the at least one aperture comprises a channel extending through the first end and through the second end.

14. A plant cradle comprising:
a main body including a first end and a second end;
an outer surface extending from the first end to the second end, the outer surface comprising at least one ridge adjacent at least one first surface; and
at least one aperture extending at least partially through the main body from the first end towards the second end and configured and arranged to hold a plant.

15. The plant cradle of claim 14, wherein the at least one first surface comprises a substantially concave surface.

16. The plant cradle of claim 14, wherein the main body comprises a polymer.

17. The plant cradle of claim 16, wherein the polymer comprises a foamed polymer.

18. The plant cradle of claim 16, wherein the polymer comprises at least one of a polyethylene-based polymer, a polypolyurethane-based polymer, a polyether-based polymer, a polypropylene-based polymer, a polystyrene-based polymer, a polymethacrylimide-based polymer, a polyvinylchloride-base polymer, a rubber-based polymer, a cellulosic-based polymer, plant-derived cellulosic fibers, plant-oil derived polymer, and mixtures thereof.

19. The plant cradle of claim 14, wherein the main body comprises at least one of a polymer fiber, polymer mesh, polymer weave, and polymer mat.

20. The plant cradle of claim 14, wherein the at least one aperture comprises a channel extending through the first end and through the second end.
